(19) United States
(12) Patent Application Publication
(10) Pub. No.: US 2010/0162858 A1
(43) Pub. Date: Jul. 1, 2010

(54) ADJUSTABLE RATCHET SYSTEM

(76) Inventor: David H. Rogers, West Palm Beach, FL (US)

Correspondence Address: MAIER & MAIER, PLLC, 1000 DUKE STREET, ALEXANDRIA, VA, 22314, US

(21) Appl. No.: 12/719,309

(22) Filed: Mar. 8, 2010

Related U.S. Application Data
(63) Continuation-in-part of application No. 12/230,222, filed on Aug. 26, 2008.

(51) Int. Cl. B25B 13/46; B25B 23/16

(52) U.S. Cl. 81/63.1; 81/60; 81/177.8

(57) ABSTRACT

An adjustable ratchet system is disclosed. An adjustable ratchet system may include an adjustable ratchet having a handle and a tang attached to the handle. The tang may have a terminal end opposite the handle where the tang may include a plurality of arms extending there from. The adjustable ratchet may also include a ratchet assembly which may include a unidirectional ratcheting drive ratchet and at least one pivot arm. The at least one pivot arm may lie on an axis and the ratchet assembly may rotate 360 degrees about that axis.

### RELATED APPLICATIONS

The present invention is a continuation-in-part and claims priority under 35 U.S.C. §120 to U.S. patent application Ser. No. 12/230,222, filed on Aug. 26, 2008, the disclosure of which is incorporated by reference herein in its entirety.

### BACKGROUND

Fasteners such as bolts are frequently tightened and loosened using tools which surround and grip an end of a fastener and rotate it in clockwise or counterclockwise directions to tighten or loosen the fastener, respectively. Often a ratchet utilizing an appropriately sized socket is used to surround and grip the fastener. The ratchet mechanism enables repeated rotations to be made without continually turning a wrench and then lifting and repositioning it. A ratchet having a ratcheting mechanism may be repeatedly rotated both clockwise and counterclockwise but causing the fastener to actually be rotated in only a single desired direction.

Fasteners may also include screws which generally have a head that may be rotated using a driver tool such as a screwdriver. Using a screwdriver or a driver bit enables this type of fastener to be initially installed and later adjusted. A driver bit usually includes a tip that is complementary to the head of the fastener.

Ratchets and screwdrivers are often used in commercial construction and personal home or vehicle repair. Ratchets and screwdrivers are also used to tighten or loosen fasteners of varying size and construction. This varying demand often times requires ratchets and screwdrivers that are also of varying size and construction.

### SUMMARY

In an exemplary embodiment an adjustable ratchet system may include an adjustable ratchet with a handle and a tang attached to the handle. The tang may have a terminal end opposite the handle where the tang may include a plurality of arms extending there from. The adjustable ratchet may also include a ratchet assembly which may include a unidirectional ratcheting drive ratchet and at least one pivot arm. The at least one pivot arm may lie on an axis and the ratchet assembly may rotate 360 degrees about that axis.

In another exemplary embodiment an adjustable ratchet system may include pressure bar with a handle and a tang attached to the handle. The tang may have a terminal end opposite the handle where the tang may include a plurality of arms extending there from. The pressure bar may also include a claw and a ratchet assembly. The ratchet assembly may include a ratcheting mechanism and a slider which may be moveable along the tang.

### BRIEF DESCRIPTION OF THE FIGURES

Advantages of embodiments of the adjustable ratchet system will be apparent from the following detailed description of the exemplary embodiments thereof, which description should be considered in conjunction with the accompanying drawings in which:

FIG. 1 is an exploded perspective view of an exemplary embodiment of a ratchet assembly.

FIG. 2a is a side view of an exemplary embodiment of an adjustable ratchet.

FIG. 2b is a side view of an exemplary embodiment of an adjustable ratchet illustrating an angled ratchet assembly.

FIG. 2c is a side view of an exemplary embodiment of an adjustable ratchet illustrating a further angled ratchet assembly.

FIG. 2d is a front view of an exemplary embodiment of an adjustable ratchet.

FIG. 3a is an exploded perspective view of an exemplary embodiment of a pressure bar.

FIG. 3b is a side view of an exemplary embodiment of a pressure bar illustrating an extended claw.

FIG. 3c is a side view of an exemplary embodiment of a pressure bar illustrating a retracted claw.

### DETAILED DESCRIPTION

Aspects of the adjustable ratchet system are disclosed in the following description and related drawings directed to specific embodiments of the adjustable ratchet system. Alternate embodiments may be devised without departing from the spirit or the scope of the adjustable ratchet system. Additionally, well-known elements of exemplary embodiments of the adjustable ratchet system will not be described in detail or will be omitted so as not to obscure the relevant details of the adjustable ratchet system. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the adjustable ratchet system” or “embodiments” do not require that all embodiments of the adjustable ratchet system include the discussed feature, advantage or mode of operation.

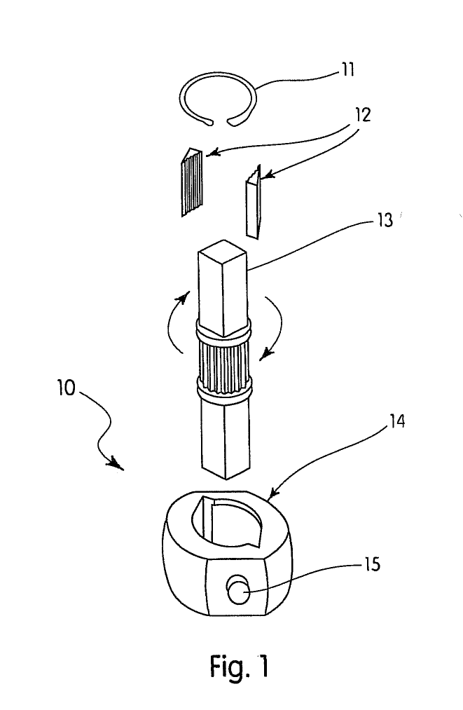

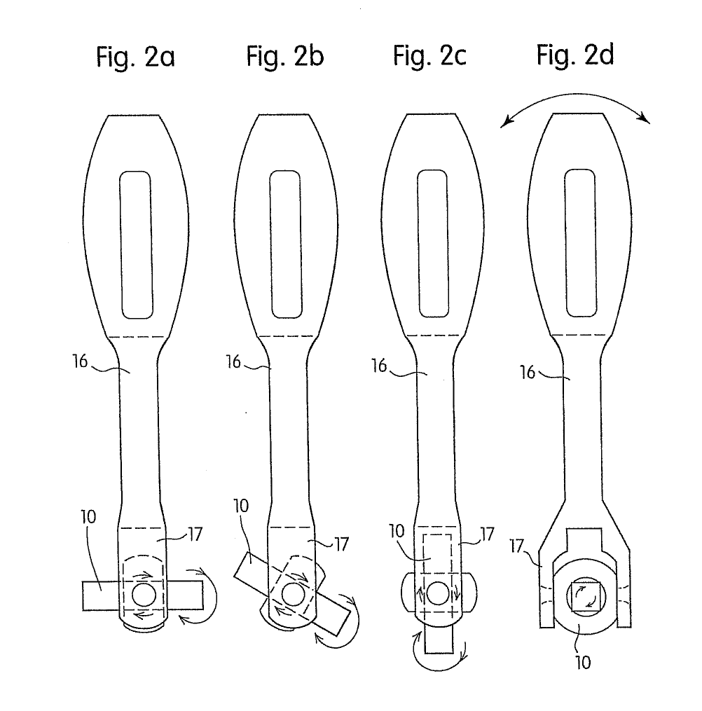

As generally shown in FIGS. 1-2d, an exemplary ratchet system may include an adjustable ratchet with a ratchet assembly 10. The ratchet assembly 10 may include a ratchet housing 14 which may be substantially cylindrical in shape or may be manufactured of in any other desired shape. The ratchet assembly 10 may also include a ratchet drive 13 which may include a receiver at either or both terminal ends for receiving sockets or drive tips. Use of the ratchet drive 13 as a nut driver or a screw driver may be accomplished, for example, through the use of standard drive tips or any other desired drive tips.

The ratchet housing 14 may receive the ratchet drive 13 through an opening in the center of the ratchet housing 14. The drive ratchet 13 may be engaged by two ratchet sliding wedges 12 via a geared center portion of the drive ratchet 13. In another exemplary embodiment additional ratchet sliding wedges 12 may be used, for example, 3 or 4 sliding wedges 12 may engage the drive ratchet 13 or as many as desired by one skilled in the art. Sliding wedges 12 may be used to facilitate unidirectional rotation or bidirectional of the drive ratchet in a ratchet-type motion with respect to the ratchet housing 14. Sliding wedges 12 may also facilitate slippage between sliding wedges 12 and ratchet drive 13 when excessive torque is applied to ratchet drive 13. Such slippage may facilitate minimizing damage to sliding wedges 12 and ratchet drive 13 that may result from the application of excessive torque.

Additionally, sliding wedges 12 may be inserted into slots and held in place within the center opening of the ratchet housing 14. A snap ring 11 may be used to retain the sliding wedges 12 and drive ratchet 13 in place within the ratchet housing 14 while enabling a free range of motion during use of the drive ratchet. In another exemplary embodiment, multiple snap rings 11 may be used, or alternatively, any other retaining mechanism that would retain the drive ratchet 13 and sliding wedges 12 within the ratchet housing 14 while enabling a free range of motion during use may also be used.

Ratchet housing 14 may also include pivots 15. The pivots 15 may be located on opposing sides of the ratchet housing 14 and may be used to attach the ratchet assembly 10 to the arms 17 of the adjustable ratchet. The arms 17 may extend from a terminal end of the tang 16 opposite of the handle portion. Each of the arms 17 may include a hole for receiving a corresponding pivot 15 of the ratchet housing 14.

In an exemplary embodiment, as generally shown in FIGS. 2a-2d, the pivots 15 may enable the ratchet assembly to rotate 360 degrees independent of the arms 17 extending from the tang 16. This may facilitate the use of the drive ratchet 13 at variable angles up to 360 degrees. Additionally, due to the unidirectional rotation of the drive ratchet 13, a user can alternate between ratcheting in a clockwise and counter-clockwise direction (tightening and loosening, respectively), simply by rotating the ratchet assembly 10, 180 degrees so the opposite end of the drive ratchet 13 is in the working position. This adjustment of the ratchet assembly can drastically decrease time wasted on changing the operating ratcheting direction of the drive ratchet 13. The adjustable ratchet may also eliminate the need for a forward/reverse lever and other associated operational components of a traditional ratchet, thus creating a ratchet that may be easier to manufacture and less likely to have failing or broken operational components. Likewise, this system may also be used with a bidirectional ratchet system as is known to one having ordinary skill in the art.

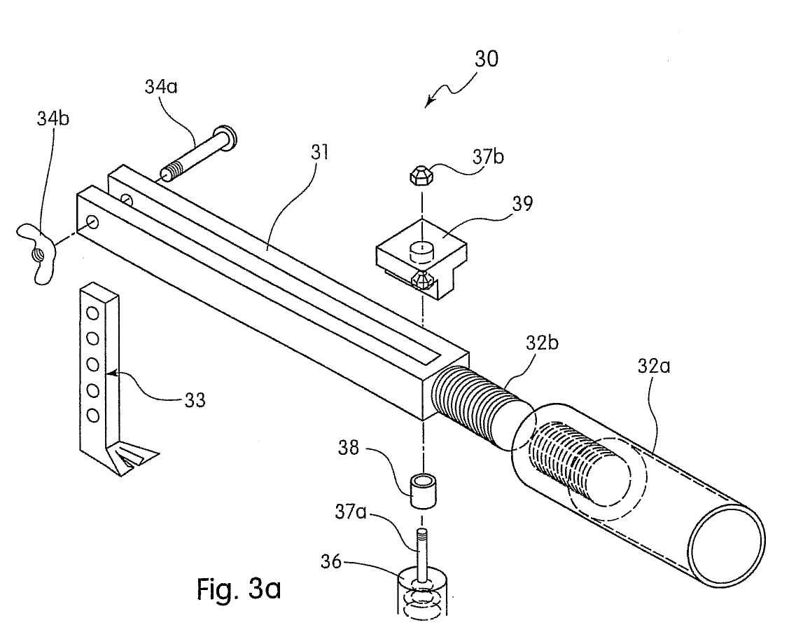

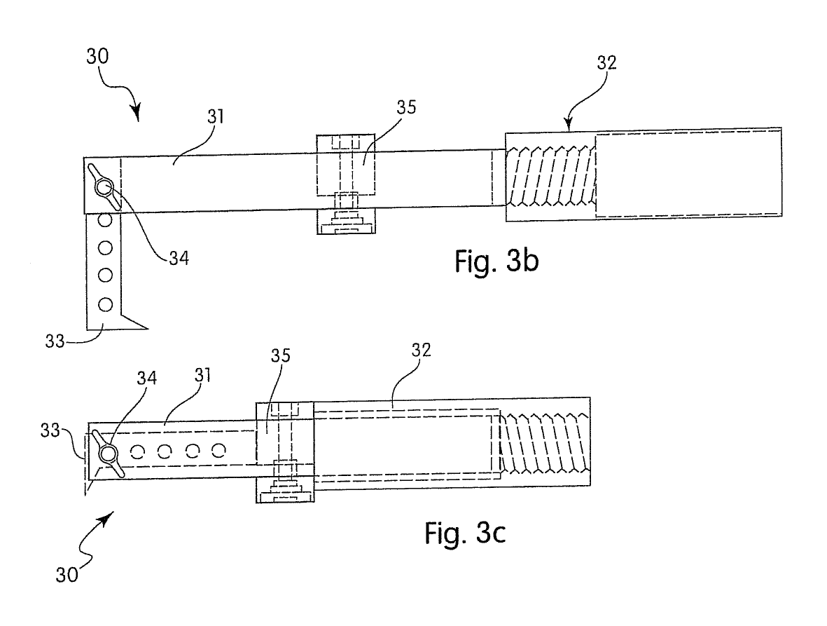

An exemplary ratchet system may also include a pressure bar 30, as generally illustrated in FIGS. 3a-3c. The pressure bar 30 may include a tang 31 which may be split into two arms. The arms 31 may be of equal or differing length and may have a consistent gap between the two. The gap may run the entire length of the tang 31 or any alternative predetermined length. At a terminating end of the tang 31 may have a protruding portion 32a which may be connected with a handle 32a. In an exemplary embodiment, protruding portion 32b may be threaded to mate with a threaded opening of the handle 32a. Handle 32a may have an opening at each of the two terminating ends. As shown in FIGS. 3b and 3c, the handle assembly 32 may be connected to the protruding portion 32a in an extended position (FIG. 3b) or in a retracted position (FIG. 3c). These two handle 32b positions may provide a user with the ability to extend the handle 32b during use of the pressure bar 30 and then reverse the handle 32b, for example, during non-use of the pressure bar 30, which can decrease the overall storage space required for the pressure bar 30.

In another exemplary embodiment, the pressure bar 30 may include a claw 33. The claw 33 may be attached to the pressure bar 30 at a terminal end of the tang 31, opposite the handle assembly 32. The claw 33 may be attached to the tang 31 via a bolt 34a and wing nut 34b. In additional exemplary embodiments the claw 33 may be attached to the tang 31 by any desired fastening mechanism, know to one skilled in the art, which may allow the claw 33 to pivot with respect to the tang 31.

Claw 33 may include a plurality of openings along its length which may correspond in size to the bolt 34a and may facilitate the adjustability of the length of the claw 33. Alternative adjustability mechanisms known to one skilled in the art can also be used to adjust the length of the claw 33. Claw 33 can be pivoted to a 90 degree angle with respect to the tang 31 (as shown in FIG. 3b), or any other desired angle, during use and may be retracted (as shown in FIG. 3c) between the arms of the tang 31 during non-use.

Claw 33 may also include a forked portion extending from a terminal end of the claw 33 opposite the tang 31 and the forked portion may facilitate anchoring claw 33, which may thereby anchor the pressure bar 30 as a whole, through the engagement of the forked portion of the claw 33 with fasteners such as, nails, screws and bolts or any other desired fasteners.

In another exemplary embodiment, the adjustable ratchet 30 may include a slider assembly 35, as generally shown in FIGS. 3a-3c. The slider assembly 35 may include a ratchet cup 36 which may include a recess configured to receive a ratchet drive with a forward/reversing lever. The ratchet cup 36 may be configured to receive, for example, a ¼ inch square drive, ⅜ inch square drive, any standard ratchet drives or any other desired drives. Additionally, ratchet cup 36 may engage the ratchet housing 14 or ratchet drive 13 of an adjustable ratchet or any other desired ratchet.

The slider assembly 35 may also include a slider bearing 38 and a slider keeper 39. The slider keeper 39 may be formed in a T-shape where the substantially planar portion lies on a side of the tang 31 opposite of the ratchet cup 36. The slider keeper 39 may also have a portion formed to be inserted into the gap between the arms of the tang 31. The slider keeper 39 may add stability and guidance to the slider assembly 35 when a user adjusts the slider assembly along the length of the tang 31. Slider bearing 38 can be placed between the slider keeper 39 and the ratchet cup 36 and may also facilitate and improve the ability of the slider assembly 35 to slide along the length of the tang 31. The ratchet cup 36, slider bearing 38 and slider keeper 39 may be secured together by slider bolt 37a and nut 37b, or any other desired securing mechanism know to one skilled in the art.

In an exemplary embodiment, the slider assembly 35 can be adjusted along the length of the tang 31, through the gap between the arms of the tang 31, as necessary to improve the ability to engage an adjustable ratchet or other desired ratchet with the ratchet cup 36, which may in turn engage fasteners or other work pieces. This configuration can also improve a user's ability to generate additional leverage to a ratchet because the claw 33 of the pressure bar 30 may be anchored to a work piece and downward force may be transferred to the ratchet by applying additional downward force on the handle assembly 32 of the pressure bar 30.

In another exemplary embodiment, additional downward pressure can be added to the pressure bar 30 via blunt force by, for example, a hammer applied in a downward motion on the planar portion of the slider keeper 39. This additional downward force can be implemented to loosen, for example, a frozen or stuck faster. The blunt downward force may unseat a fastener, enabling the ratcheting and removal of the fastener.

In an exemplary embodiment, specialized chisel tips may also be used to facilitate the removal or unseating of desired fasteners. These chisel tips may be made of specialized material of high hardness and may be configured with predetermined angles which may increase the ability of the chisel tip to engage a stripped or otherwise stuck fastener. These specialized chisel tips may become even more effective when used in combination with an adjustable ratchet and pressure bar 30. The chisel tips may also have various shaped heads, for example, Philips, slot, Allen or any other desired head shape. Using the pressure bar 30 to exert additional force on the adjustable ratchet and, therefore on the chisel tip, may increase the ability of the chisel tip to penetrate and engage a desired stripped or otherwise stuck fastener. Similarly, for example, a hammer can be also be used to exert additional downward force on the slider keeper 39 which may transfer that downward force to a chisel tip which may facilitate seating the chisel tip into a desired fastener.

The foregoing description and accompanying drawings illustrate the principles, preferred embodiments and modes of operation of the adjustable ratchet system. However, the adjustable ratchet system should not be construed as being limited to the particular embodiments discussed above. Additional variations of the embodiments discussed above will be appreciated by those skilled in the art. For example, a sliding wedge mechanism can also be designed in production of a bidirectional ratchet system.

Therefore, the above-described embodiments should be regarded as illustrative rather than restrictive. Accordingly, it should be appreciated that variations to those embodiments can be made by those skilled in the art without departing from the scope of the adjustable ratchet system as defined by the following claims.

What is claimed is:

1. An adjustable ratchet system comprising:
an adjustable ratchet comprising:
a handle;
a tang attached to the handle, wherein the tang has a terminal end opposite the handle, wherein the tang includes a plurality of arms extending from the terminal end;
a ratchet assembly, wherein the ratchet assembly includes:
a unidirectional ratcheting drive ratchet;
at least one pivot arm, wherein the pivot arm lies on an axis;
wherein, the ratchet assembly rotates about the axis 360 degrees.

2. The adjustable ratchet system of claim 1, wherein the ratchet drive receives a socket.

3. The adjustable ratchet system of claim 1, wherein the ratchet drive receives sockets of varying size.

4. The adjustable ratchet system of claim 1, wherein the ratchet assembly also includes:
at least one sliding wedge facilitating the ratcheting ability of the drive ratchet.

5. The adjustable ratchet system of claim 1, wherein the ratchet assembly also includes:
a snap ring, retaining the at least one sliding wedge and ratchet drive within the ratchet assembly.

6. The adjustable ratchet system of claim 1, wherein the ratchet drive includes multiple receivers.

7. The adjustable ratchet system of claim 6, wherein a first receiver is located 180 degrees from a second receiver.

8. An adjustable ratchet system comprising:
a pressure bar comprising:
a handle;
a tang attached to the handle, wherein the tang has a terminal end opposite the handle, wherein the tang includes a plurality of arms extending from the terminal end;
a claw;
a slider, moveable along the tang.

9. The adjustable ratchet system of claim 8, wherein the claw includes a pivot, enabling the claw to pivot with respect to the tang.

10. The adjustable ratchet system of claim 9, wherein the length of the claw is adjustable at the pivot.

11. The adjustable ratchet system of claim 8, wherein the tang includes two arms extending from the terminal end, wherein the slider is movable between the two arms.

12. The adjustable ratchet system of claim 11, wherein a terminal end of the slider has a width that is greater than the width between the two arms of the tang.

13. The adjustable ratchet system of claim 8, wherein the handle is removable.

14. The adjustable ratchet system of claim 13, wherein the handle is threadedly engaged with the tang.

15. The adjustable ratchet system of claim 14, wherein the handle is threaded at more than one end of the handle for engaging the tang in multiple configurations.

16. The adjustable ratchet system of claim 8, wherein the slider includes:
a ratchet cup, wherein the ratchet cup is configured to receive the housing of a ratchet.

17. An adjustable ratchet system comprising:
an adjustable ratchet comprising:
a handle;
a tang attached to the handle, wherein the tang has a terminal end opposite the handle, wherein the tang includes a plurality of arms extending from the terminal end;
a ratchet assembly, wherein the ratchet assembly includes:
a bidirectional ratcheting drive ratchet;
at least one pivot arm, wherein the pivot arm lies on an axis;
wherein, the ratchet assembly rotates about the axis 360 degrees.
